(19) United States
(12) Patent Application Publication
(10) Pub. No.: US 2025/0070196 A1
(43) Pub. Date: Feb. 27, 2025

(54) TESTING APPARATUS AND TESTING SYSTEM FOR FUEL CELL STACK

(71) Applicant: Robert Bosch GmbH, Stuttgart (DE)

(72) Inventors: Qiushi Wang, Suzhou (CN); Jian Zhou, Suzhou (CN)

(21) Appl. No.: 18/809,583

(22) Filed: Aug. 20, 2024

(30) Foreign Application Priority Data
Aug. 24, 2023 (CN) 2023 1108 0086.9

(51) Int. Cl. H01M 8/04119; H01M 8/04007; H01M 8/04082; H01M 8/04701; H01M 8/04746; H01M 8/04828

(52) U.S. Cl. CPC H01M 8/04126; H01M 8/04067; H01M 8/04201; H01M 8/04708; H01M 8/04761; H01M 8/04835

(57) ABSTRACT

A testing apparatus and testing system for a fuel cell stack is disclosed. The testing apparatus includes a gas supply control module and a backpressure control module, both of which are detachably disposed within the main body. The gas supply control module incudes: a mass flow controller for controlling the flow rate of dry gas; a mixing tube, coupled to the mass flow controller and adapted to receive steam and dry gas, wherein the dry gas and steam are mixed in the mixing tube to form humidified gas; and a first gas heat exchanger, coupled to the mixing tube and adapted to be coupled to the fuel cell stack, wherein the first gas heat exchanger is configured to provide temperature-regulated humidified gas to the fuel cell stack. The backpressure control module is adapted to be coupled to the fuel cell stack and is configured to regulate the pressure of the exhaust gas from the fuel cell stack. In this manner, the modular design allows for the centralized arrangement of relevant components, bringing the total volume of the gas chamber in the gas supply circuit closer to the total volume of the gas chamber at the vehicle level, thereby improving testing performance.

This application claims priority under 35 U.S.C. § 119 to patent application no. CN 2023 1108 0086.9, filed on Aug. 24, 2023 in China, the disclosure of which is incorporated herein by reference in its entirety.

Exemplary examples of the present disclosure relate to the field of fuel cells, and more specifically, to testing apparatuses, electronic devices, and computer-readable storage media for maintaining assets in a factory.

### BACKGROUND

In the field of Proton Exchange Membrane Fuel Cell (PEMFC) products, fuel cell systems that provide power to fuel cell vehicles typically consist of a fuel cell stack and multiple auxiliary components. The fuel cell stack is a power generation device that utilizes the electrochemical reaction of hydrogen and oxygen, and different proton exchange membranes require different humidity levels to achieve the highest power generation efficiency and the longest service life.

Since the fuel cell stack is a crucial component of fuel cell products, its performance directly affects the final performance of the fuel cell system. Therefore, specialized testing apparatuses are required during the research and development, as well as the production stages, to test the performance of the fuel cell stack. Such apparatuses are commonly referred to as fuel cell stack testing apparatuses, also known as stack test benches.

A stack test bench simulates different operating conditions by controlling the flow rate, pressure, temperature, and humidity of hydrogen, air, or other gases entering the fuel cell product, thereby testing the performance of the fuel cell product. During the operation of the fuel cell stack, the hydrogen and oxygen entering the stack need to be humidified. Common humidification methods include humidification tanks (bubbling, spraying) and steam humidification.

### SUMMARY

An example of the present disclosure provides a modular solution for a testing apparatus for fuel cell stacks.

A first aspect of the present disclosure relates to a testing apparatus for a fuel cell stack. The testing apparatus includes: a main body, adapted to accommodate the fuel cell stack to be tested; a gas supply control module, detachably disposed in the main body and including: a mass flow controller, configured to control the flow rate of received dry gas, wherein the dry gas includes hydrogen or air, or includes hydrogen or oxygen; a mixing tube, coupled to the mass flow controller and adapted to receive steam, wherein the dry gas from the mass flow controller is mixed with the received steam in the mixing tube to form humidified gas; a first gas heat exchanger, coupled to the mixing tube and adapted to be coupled to the fuel cell stack, wherein the first gas heat exchanger is configured to provide temperature-regulated humidified gas to the fuel cell stack; and a backpressure control module, detachably disposed in the main body and adapted to be coupled to the fuel cell stack, configured to regulate the pressure and temperature of the exhaust gas from the fuel cell stack.

According to the example of the present disclosure, by configuring the components for controlling the gas supply and the components for controlling the exhaust gas as replaceable modules, the relevant components are centrally disposed, reducing the length of the pipelines between the components. At the same time, the compact arrangement of the modules allows them to be flexibly positioned in the testing apparatus, enabling the modules to be closer to the stack to be tested, thereby further reducing the total volume of the gas chamber in the gas supply loop, making it closer to the total volume of the gas chamber in the real application scenario of the stack, thus improving the testing performance. Additionally, the modular design allows the testing apparatus to be used in scenarios with different testing power requirements, thereby enhancing the applicability of the testing apparatus.

In some examples, the gas supply control module further includes: a proportional valve, coupled to the mixing tube and configured to adjust the mass of steam entering the mixing tube. In such examples, by providing a proportional valve on the mixing tube, the mass of steam entering the mixing tube can be adjusted to match the dry gas.

In some examples, the gas supply control module further includes: a second gas heat exchanger, coupled between the mixing tube and the mass flow controller, configured to preheat the dry gas flowing from the mass flow controller to the mixing tube. In such examples, by providing preheating, the dry gas can be preheated before entering the mixing tube, thereby preventing condensation when encountering steam.

In some examples, the first gas heat exchanger and the second gas heat exchanger extend parallelly, and the mixing tube extends from the first gas heat exchanger to the second gas heat exchanger in a direction perpendicular to the first gas heat exchanger. In such examples, by making the two gas heat exchangers extend parallelly and the mixing tube extend perpendicularly to both, the length of the mixing tube can be minimized.

In some examples, the mixing tube includes a tube body extending between the first gas heat exchanger and the second gas heat exchanger and a steam pipeline communicating with the tube body and extending in a direction perpendicular to the tube body. In such examples, by making the steam pipeline extend perpendicularly to the tube body, the space of the module can be fully utilized.

In some examples, the first gas heat exchanger includes a first surface extending in a first direction, and the second gas heat exchanger includes a third surface parallel to the first surface, with a humid gas inlet provided on the first surface and a dry gas outlet provided on the third surface, the humid gas inlet and the dry gas outlet aligned, and the mixing tube extending from the humid gas inlet to the dry gas outlet. In such examples, by providing aligned gas inlets and outlets, the mixing tube can extend in a straight line perpendicular to the gas heat exchangers, thereby minimizing the length of the mixing tube.

In some examples, the second gas heat exchanger further includes a fourth surface perpendicular to the third surface, with a dry gas inlet suitable for being coupled to the mass flow controller provided on the fourth surface. In such examples, by providing the dry gas inlet on the fourth surface, the gas heat exchanger and the mass flow controller can extend in different directions, thereby reducing the length of the module in one direction, making the module more compact.

In some examples, the first gas heat exchanger further includes a second surface perpendicular to the first surface, with a humid gas outlet suitable for being coupled to the fuel cell stack provided on the second surface.

In some examples, the gas supply control module further includes: A fourth gas heat exchanger, coupled to the inlet of the mass flow controller and configured to preheat the dry gas entering the mass flow controller. In such examples, by providing a gas heat exchanger at the inlet of the mass flow controller, the dry gas can be preheated to avoid condensation in the mixing tube.

In some examples, the backpressure control module includes: a backpressure valve, configured to regulate the pressure of the exhaust gas; and a third gas heat exchanger, configured to regulate the temperature of the exhaust gas. In such examples, the backpressure valve and the gas heat exchanger can be used to regulate the temperature and pressure of the exhaust gas.

In some examples, the third gas heat exchanger is adapted to be coupled to the fuel cell stack, with one end of the backpressure valve coupled to the third gas heat exchanger and the other end adapted to be coupled to an exhaust gas treatment device, or wherein one end of the backpressure valve is adapted to be coupled to the fuel cell stack and the other end is coupled to the third gas heat exchanger, with the third gas heat exchanger adapted to be coupled to the exhaust gas treatment device. In such examples, the positions of the backpressure valve and the gas heat exchanger can be interchanged, improving flexibility.

In some examples, the testing apparatus further includes additional gas supply control modules and additional backpressure control modules for different testing power scenarios, wherein the additional backpressure control modules and additional gas supply control modules are adapted to be disposed in the main body to replace the gas supply control module and the backpressure control module. In such examples, by providing modules for different testing power scenarios, the flexibility of testing is improved.

A second aspect of the present disclosure relates to a testing system for a fuel cell stack. The testing system includes: the testing apparatus for a fuel cell stack; and a fuel cell stack, including: an input end, coupled to the gas supply control module in the testing apparatus; and an output end, coupled to the backpressure control module in the testing apparatus.

In some examples, the testing system further includes: a steam source, disposed outside or inside the testing apparatus and configured to provide steam.

### BRIEF DESCRIPTION OF THE DRAWINGS

The above and other objectives, features, and advantages of the examples of the present disclosure will become more readily understood by referring to the following detailed description in conjunction with the accompanying drawings. In the drawings, multiple examples of the present disclosure will be described by way of example and not limitation, wherein:

FIG. 1 shows a schematic diagram of a testing system according to an example of the present disclosure;

FIG. 2 shows a schematic block diagram of a testing system according to an example of the present disclosure;

FIG. 3 shows a schematic principle diagram of the gas circuit of a testing system according to an example of the present disclosure;

FIG. 4 shows a schematic diagram of a gas supply control module according to an example of the present disclosure; and

FIG. 5 shows a schematic diagram of testing equipment according to an example of the present disclosure.

It should be understood that similar or identical reference numerals may be used in the figures where feasible, and similar or identical reference numerals may denote similar or identical functions.

### DETAILED DESCRIPTION

The principles of the present disclosure will now be described with reference to various exemplary examples shown in the accompanying drawings. It should be understood that the descriptions of these examples are merely to enable those skilled in the art to better understand and further implement the present disclosure, and are not intended to limit the scope of the present disclosure in any way. Those skilled in the art will readily recognize that alternative examples of the structures and testing equipment described herein can be employed without departing from the principles of the present disclosure as described herein.

As discussed above, stack test benches typically can only test fuel cells with specific power ratings, and the components within the stack test bench are fixedly deployed inside the test bench. In such a pipeline setup, the routing of the pipelines is usually not compact enough. Particularly in the use of bubbling and spraying humidification schemes, since the humidification equipment is placed in the gas supply circuit, the total volume of the gas supply circuit pipelines increases, especially much larger than the pipeline volume in actual fuel cell systems. This results in the inability to simulate the real application scenarios of the stack in the fuel cell system on the stack test bench, especially the inability to simulate the dynamic performance of the stack, i.e., the inability to achieve rapid pressure build-up and load pull. Specifically, if load pulling is performed at low flow rates, a sudden voltage drop may occur, leading to reverse polarity. In severe cases, this may cause the stack to burn out. Therefore, such stack test benches have safety hazards. At the same time, the fixed deployment of components limits the test equipment to single power testing, reducing its applicability.

In view of this, an example of the present disclosure proposes a scheme for modularizing components associated with the total volume of pipelines in the gas supply circuit. In this scheme, the modularization of components allows related components to be centrally disposed, reducing the length of the pipelines between each component. At the same time, the compact arrangement of the modules allows them to be flexibly positioned in the testing apparatus, enabling the modules to be closer to the stack to be tested, thereby further reducing the total volume of the gas chamber in the gas supply loop, making it closer to the total volume of the gas chamber in the real application scenario of the stack, thus improving the testing performance. Additionally, the modular design allows the testing apparatus to be used in scenarios with different testing power requirements, thereby enhancing the applicability of the testing apparatus.

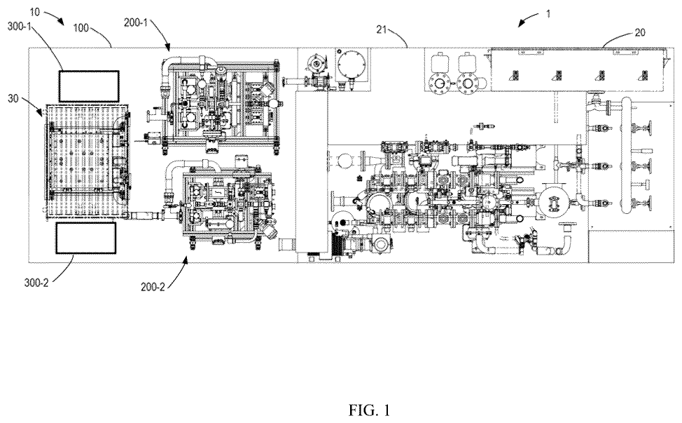

Below, the detailed description of a testing system for a fuel cell stack according to examples of the present disclosure will be provided in conjunction with FIGS. 1 to 5.

FIG. 1 shows a schematic diagram of a testing system according to an example of the present disclosure. As shown in FIG. 1, the testing system for a fuel cell stack includes a testing chamber 10 for the fuel cell stack, a medium supply chamber 20 disposed side by side with the testing chamber 10, and a fuel cell stack 30 to be tested, placed in the testing chamber 10. In the example shown in FIG. 1, the medium supply chamber 20 and the testing chamber 10 are integrated together. Here, the testing chamber 10 can be referred to as the testing chamber, while the medium supply chamber 20 can be referred to as the pipeline chamber. The medium supply chamber 20 can be coupled to the plant's medium sources (such as a hydrogen source for stack testing, an air source, a steam source for providing humidified steam, a coolant source for providing cooling functionality, and other process gas sources) and supply the medium to the testing chamber 10. For example, the medium supply chamber 20 may include multiple pipelines for delivering different media, and when the medium supply chamber 20 and the testing chamber 10 are assembled together, the multiple pipelines may extend into the testing chamber 10 to connect with components in the testing chamber 10 and supply the medium to the components in the testing chamber 10.

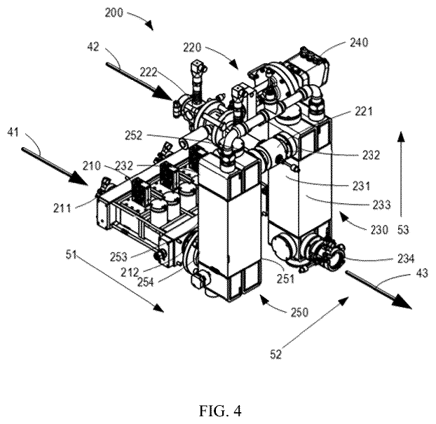

As shown in FIG. 1, the testing chamber 10 includes a main body 100, removable gas supply control modules 200-1 and 200-2 (collectively referred to as gas supply control modules 200) disposed in the main body 100, and backpressure control modules 300-1 and 300-2 (collectively referred to as backpressure control modules 300). During stack testing, the gas supply control modules 200 may be coupled to corresponding pipelines of the medium supply chamber 20 to receive dry gas and steam. In the examples of the present disclosure, the dry gas may include hydrogen or air, or it may include hydrogen or oxygen. For example, the gas supply control module 200-1 may receive dry hydrogen and steam from the medium supply chamber 20 and provide humidified hydrogen to the cathode of the fuel cell stack 30. Correspondingly, the gas supply control module 200-2 may receive dry oxygen or air and steam from the medium supply chamber 20 and provide oxygen or air to the anode of the fuel cell stack 30. The specific structure of the gas supply control modules 200 will be described in detail later in conjunction with FIG. 4.

The backpressure control module 300-1 of the testing chamber 10 is disposed on the cathode side of the fuel cell stack 30, and the backpressure control module 300-2 of the testing chamber 10 is disposed on the anode side of the fuel cell stack 30. During stack testing, the backpressure control module 300-1 is coupled to the fuel cell stack 30 to receive cathode exhaust gas, and the backpressure control module 300-2 is coupled to the fuel cell stack 30 to receive anode exhaust gas.

In the example shown in FIG. 1, components associated with the total volume of the test pipeline in the gas supply circuit are modularized into a gas supply control module and a backpressure control module, respectively. This makes the gas supply circuit very compact, reducing the pipeline volume between various components and bringing it closer to the total gas chamber volume of the fuel cell in real usage scenarios, thereby providing better test results. Additionally, the compact structure can reduce the overall size of the testing apparatus.

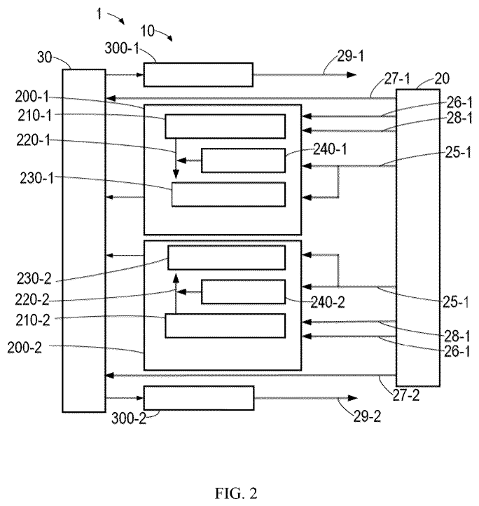

FIG. 2 shows a schematic block diagram of a testing system according to an example of the present disclosure. As shown in FIG. 2, the testing system for a fuel cell stack includes a testing chamber 10 for the fuel cell stack, a medium supply chamber 20, and a fuel cell stack 30 to be tested. In the example shown in FIG. 2, the medium supply chamber 20 can serve as a medium source for various media to provide the required media to the testing chamber 10. In this example, the medium supply chamber 20 may provide hydrogen, air, steam, cooling water, and nitrogen, among others.

As shown in FIG. 2, the testing chamber 10 includes a hydrogen gas supply circuit and an air supply circuit. The hydrogen gas supply circuit includes a gas supply control module 200-1 and a backpressure control module 300-1. Conversely, the air supply circuit includes a gas supply control module 200-2 and a backpressure control module 300-2.

The gas supply control modules 200-1, 200-2 and the backpressure control modules 300-1, 300-2 are included in this example. The gas supply control module 200-1 is positioned on the cathode side of the fuel cell stack 30. The gas supply control module 200-1 includes a mass flow controller 210-1. The mass flow controller (MFC) can be used for precise measurement and control of the mass flow of gases or liquids and typically consists of components such as a circuit board, sensors, inlet and outlet gas pipeline connectors, a shunt pipeline, a casing, and a regulating valve. The mass flow controller 210-1 may be coupled to the dry gas pipeline 26-1 of the medium supply chamber 20 for supplying dry hydrogen and may control the mass flow of the received hydrogen to adapt the hydrogen supplied to the fuel cell stack 30 for the test power of the fuel cell stack 30. The gas supply control module 200-1 is also coupled to the medium supply chamber 20 via a process pipeline 28-1 for supplying nitrogen.

The gas supply control module 200-1 also includes a mixing tube 220-1. The mixing tube 220-1 may, for example, include three ports. The first port of the three ports may be coupled to the mass flow controller 210-1 to receive dry hydrogen from the mass flow controller 210-1. The second port of the three ports may be coupled to the steam pipeline 25-1 of the medium supply chamber 20 to receive steam. Additionally, a valve 240-1 for regulating the mass of steam entering the mixing tube 220-1 may be disposed at the second port. When the dry hydrogen from the mass flow controller 210-1 meets the steam in the mixing tube 220-1, they mix to form humidified gas. The third port of the three ports is coupled to the gas heat exchanger 230-1 of the gas supply control module 200-1 and delivers the humidified gas to the gas heat exchanger 230-1. The gas heat exchanger 230-1 is used to heat the humidified gas to a predetermined temperature to meet test requirements. The gas heat exchanger 230-1 of the gas supply control module 200-1 is coupled to the cathode of the fuel cell stack 30 and provides the heated humidified gas to the cathode.

The gas chamber volume associated with the gas supply circuit for testing typically refers to the gas volume from the mass flow controller to the last component in the backpressure module. In conventional stack test benches using bubble or spray humidification, a humidification tank is typically provided downstream of the mass flow controller. In this case, the total gas chamber volume of the anode and cathode circuits of the stack test bench mainly consists of the pipeline volume from the mass flow controller to the humidification tank, the volume of the humidification tank, the pipeline volume from the humidification tank to the gas heat exchanger, the volume of the gas heat exchanger, the pipeline volume from the gas heat exchanger to the stack, the volume of the stack, and the pipeline volume from the stack to the backpressure valve. In such conventional setups, the provision of the humidification tank significantly increases the gas chamber volume. Conversely, in the present disclosure, by using a steam-based humidification scheme instead of a humidification tank scheme, the volume of the humidification tank in the total gas chamber volume is completely eliminated. In this way, by using a mixing tube to mix dry gas with steam, humidification of the dry gas is achieved without the need for other humidification devices, thereby reducing the total gas chamber volume and improving test stability.

Accordingly, the gas supply control module 200-2 may be disposed on the anode side of the fuel cell stack 30. The gas supply control module 200-2 includes a mass flow controller 210-2, a mixing tube 220-2, a valve 240-2, and a gas heat exchanger 230-1. The gas supply control module 200-2 is coupled to the dry air pipeline 26-2 for supplying dry air, the process gas pipeline 28-2 for supplying nitrogen, and the steam pipeline 25-2 for supplying steam. The gas supply control module 200-2 may provide oxygen or air to the anode of the fuel cell stack 30. The structure and operating principle of the gas supply control module 200-2 are the same as those of the gas supply control module 200-1, and will not be elaborated here. It should be understood that although the modules for the cathode and anode are shown to have similar structures, the modules for the cathode and anode are configured to be suitable for the corresponding gas supply parameters and have different components due to the different gas supply parameters at the cathode and anode.

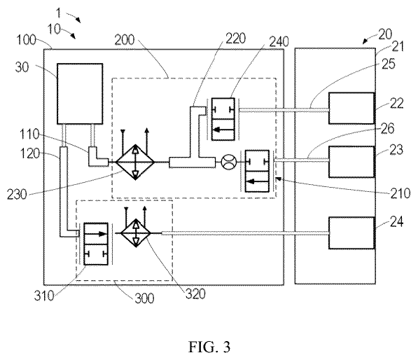

Furthermore, the fuel cell stack 30 is coupled to the medium supply apparatus 20 on the cathode side via a cooling pipeline 27-1 for receiving cooling water (e.g., deionized water), and on the anode side via a cooling pipeline 27-2 for receiving cooling water. When the humidified air and hydrogen react in the fuel cell stack 30, the cathode exhaust gas generated at the cathode enters the backpressure control module 300-1. The backpressure control module 300-1 regulates the pressure and temperature of the cathode exhaust gas, discharging it via the exhaust pipeline 27-1. Similarly, the anode exhaust gas generated at the anode enters the backpressure control module 300-2. The backpressure control module 300-2 regulates the pressure and temperature of the anode exhaust gas, discharging it via the exhaust pipeline 27-2. FIG. 3 shows a schematic principle diagram of the gas supply circuit of the testing apparatus according to an example of the present disclosure. As discussed with reference to FIG. 2, the structure and operating principle of the hydrogen gas supply circuit and the air supply circuit of the testing apparatus are the same. For brevity, only one gas supply circuit is described in detail here without loss of generality. This gas supply circuit can correspond to either the hydrogen gas supply circuit or the air/oxygen gas supply circuit.

As shown in FIG. 3, the testing system for a fuel cell stack includes a testing chamber 10 for the fuel cell stack, a medium supply chamber 20, and a fuel cell stack 30 to be tested. Here, the medium supply chamber 20 includes another main body 21. The other main body 21 is provided with a steam source 22, a dry gas source 23 (such as an air source, hydrogen source), and an exhaust gas treatment apparatus 24. The steam source 22 can be, for example, an ultrapure water steam boiler. For instance, the ultrapure water steam boiler can operate to produce high-temperature steam above 100° C.

The testing chamber 10 includes a main body 100 and a gas supply control module 200 and a backpressure control module 300 disposed in the main body 100. The gas supply control module 200 includes a mass flow controller 210, a mixing tube 220, a proportional valve 240, and a gas heat exchanger 230. In the example shown in FIG. 3, the mass flow controller 210 is implemented as an assembly consisting of a valve and a flow meter. The mass flow controller 210 is coupled to the dry gas source 23 of the medium supply chamber 20 via a dry gas pipeline 26 and can control the mass flow of the received hydrogen gas.

The gas supply control module 200 also includes a mixing tube 220. The first end of the mixing tube 220 is provided with the proportional valve 240. The proportional valve 240 is coupled to the steam source 22 of the medium supply chamber 20 via a steam pipeline 25. The proportional valve 240 can be implemented as an electromagnetic valve and controls the amount of steam injected into the dry gas, so that the steam and dry gas mix to reach the target dew point. In some examples, the proportional valve 240 can perform feedback adjustment by installing a humidity sensor before the stack inlet or by installing a steam flow meter between the proportional valve and the steam source. In some examples, the proportional valve 240 may include multiple proportional valves. In some examples, the multiple proportional valves are disposed in parallel. By providing multiple proportional valves, the range of steam adjustment can be increased, making the gas supply module suitable for more testing scenarios.

The second end of the mixing tube 220 is coupled to the mass flow controller 210 and receives dry gas from the mass flow controller 210. The dry gas from the mass flow controller 210 meets steam in the mixing tube 220, forming humidified gas. Here, the dry gas can be high-pressure gas. For example, when the dry gas is air and hydrogen, both air and hydrogen are high-pressure gases. In the case of hydrogen, the hydrogen mixes with high-temperature steam in the mixing tube 220, producing high-temperature supersaturated hydrogen. Similarly, in the case of air, the air mixes with high-temperature steam in the mixing tube 220, producing high-temperature supersaturated air. The diameter of the mixing tube 220 matches the power of the actual test. When arranging internal components, the length of the mixing tube can be kept as short as possible, and the volume of the pipeline can be minimized while meeting functional requirements.

The third end of the mixing tube 220 is coupled to the gas heat exchanger 230 of the gas supply control module 200 via a gas supply pipeline 110 and delivers the high-temperature supersaturated gas to the gas heat exchanger 230. The gas heat exchanger 230 is used to heat the humidified gas to a predetermined temperature to meet the dew point temperature, pressure, and temperature required for the test. Subsequently, the gas heat exchanger 230 is coupled to the fuel cell stack 30 and provides the temperature-regulated humidified gas to the fuel cell stack 30.

When the gas reacts in the fuel cell stack 30, the produced exhaust gas enters the backpressure control module 300 via the exhaust pipeline 120 coupled to the fuel cell stack 30. In the example shown in FIG. 3, the backpressure control module 300 includes a backpressure valve 310 for regulating the pressure of the exhaust gas and a gas heat exchanger 320 for regulating the temperature of the exhaust gas. The backpressure valve 310 is coupled to the exhaust pipeline 120. One end of the gas heat exchanger 320 is coupled to the backpressure valve 310, and the other end is coupled to the exhaust gas treatment apparatus 24 of the medium supply chamber 20 via the exhaust pipeline 27. In some examples, the gas supply pipeline 110 or the exhaust pipeline 120 may be soft or hard pipes, or gas flow channels processed by machining. In some examples, temperature, pressure, and humidity sensors may be disposed at the stack inlet or outlet.

In some examples, the gas heat exchanger 320 of the backpressure control module 300 may be coupled to the exhaust pipeline 120, and one end of the backpressure valve 310 is coupled to the gas heat exchanger 320, while the other end is coupled to the exhaust gas treatment apparatus 24 of the medium supply chamber 20 via the exhaust pipeline 27.

In some examples, the testing chamber 10 also includes additional gas supply control modules and additional backpressure control modules for other testing powers. Here, the additional backpressure control modules and additional gas supply control modules may be disposed in the main body to replace the current gas supply control module 200 and backpressure control module 300. For example, the current gas supply control module and backpressure control module can be used for testing at 10 kW power, while the additional gas supply control module and backpressure control module can be used for testing at 300 kW power. This greatly expands the applicability of the testing apparatus. It should be understood that in the context of the present disclosure, the term “removable” indicates that the module can be detached from the main body in a non-destructive manner. Meanwhile, the term “replaceable” indicates that different modules can be connected to the corresponding interface on the main body without modification.

FIG. 4 shows a schematic diagram of a gas supply control module 200 according to an example of the present disclosure. As shown in FIG. 4, the gas supply control module 200 includes a mass flow controller 210 for receiving dry gas. In the example shown in FIG. 4, the mass flow controller 210 is implemented as multiple mass flow controllers arranged in parallel in the Y direction indicated by arrow 52. The mass flow controller 210, for example, extends in the X direction indicated by arrow 51, with one end in the X direction including a first dry gas inlet 211 for receiving dry gas. The other end, away from the first dry gas inlet 211 in the X direction, includes a first dry gas outlet 212.

Unlike FIGS. 2 and 3, the gas supply control module 200 shown in FIG. 4 may include two gas heat exchangers, namely the first gas heat exchanger 230 and the second gas heat exchanger 250. The second gas heat exchanger 250 is coupled between the mixing tube 220 and the mass flow controller 210 and is configured to preheat the dry gas flowing from the mass flow controller 210 to the mixing tube 220. The first gas heat exchanger 230 and the second gas heat exchanger 250 can be identical and have a rectangular parallelepiped form. The first gas heat exchanger 230 and the second gas heat exchanger 250 extend parallelly in the Z direction indicated by arrow 53. The first gas heat exchanger 230 includes a first surface 231 extending in the Z direction, and the second gas heat exchanger 250 includes a third surface 251 parallel to the first surface 231. The first surface 231 is provided with a humid gas inlet 232, and the third surface 251 is provided with a second dry gas outlet 252. The humid gas inlet 232 is aligned with the second dry gas outlet 252.

As shown in FIG. 4, the rectangular parallelepiped body of the second gas heat exchanger 250 further includes a fourth surface 253 perpendicular to the third surface 251. A second dry gas inlet 254 is provided on the fourth surface 253. The second dry gas inlet 254 is coupled to the first dry gas outlet 212 of the mass flow controller 210. The first gas heat exchanger 230 also includes a second surface 233 perpendicular to the first surface 231. The second surface 233 is on the side of the first gas heat exchanger 230 away from the mass flow controller 210. A humid gas outlet 234 is provided on the second surface 233. The humid gas outlet 234 is coupled to the fuel cell stack 30 in the stack testing apparatus.

The mixing tube 220 of the gas supply control module 200 includes a tube body 221 extending from the humid gas inlet 232 to the second dry gas outlet 252 and a steam pipeline 222 communicating with the tube body 221 and extending in the X direction. A proportional valve 240 is provided on the steam pipeline 222.

During stack testing, dry gas enters the mass flow controller 210 from the first dry gas inlet 211 in the direction indicated by arrow 41, and the flow-regulated dry gas enters the second gas heat exchanger 250 via the connection between the first dry gas outlet 212 and the second dry gas inlet 254. The dry gas is preheated in the second gas heat exchanger 250 to prevent condensation when encountering steam. Subsequently, the preheated dry gas enters the tube body 221 of the mixing tube 220 via the second dry gas outlet 252. Simultaneously, steam enters the steam pipeline 222 from the inlet in the direction indicated by arrow 42. After being regulated by the proportional valve 240, the steam also enters the tube body 221 to mix with the dry gas, forming humidified gas. The humidified gas then enters the first gas heat exchanger 230 from the mixing tube 220 via the humid gas inlet 232. The humidified gas is heated in the first gas heat exchanger 230 and then enters the fuel cell stack in the direction indicated by arrow 43. In some examples, the second gas heat exchanger 250 can also be installed at the first dry gas inlet 211, so that the gas entering the mass flow controller 210 is preheated first.

In the example shown in FIG. 4, by arranging the two gas heat exchangers to extend parallelly and perpendicular to the mass flow controller, the gas supply control module is compact, reducing the length of the mixing tube connecting the two gas heat exchangers, while positioning the steam inlet above the mass flow controller, improving space utilization and reducing overall volume. In some exemplary examples, compared to using a humidification tank, the total volume of the gas chamber for the cathode can be reduced from 150 L to about 15 L, and the total volume of the gas chamber for the anode can be reduced from 70 L to about 5 L, making it closer to the gas chamber volume in real-world fuel cell usage scenarios, i.e., engine-level gas chamber volume, thereby significantly improving testing capabilities. It should be understood that the specific structure and corresponding dimensions of the components in the testing chamber described in this example are merely exemplary. All components capable of achieving the corresponding functions are within the scope of the present disclosure.

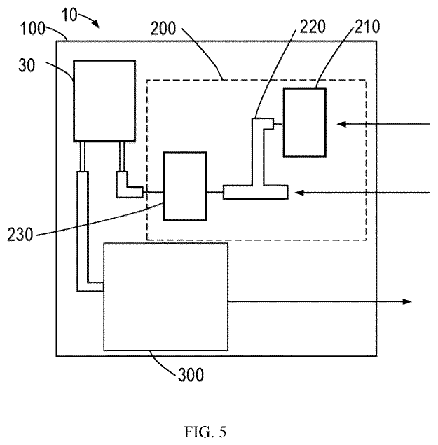

FIG. 5 shows a schematic diagram of a testing chamber 10 according to an example of the present disclosure. As shown in FIG. 5, the testing chamber 10 includes a main body 100. The main body 100 can accommodate the fuel cell stack to be tested and other components. The testing chamber 10 includes a gas supply control module 200 and a backpressure control module 300, which are removably arranged in the main body 100. The gas supply control module 200 can receive the corresponding medium from the medium supply device, humidify the medium, and control its flow rate and temperature. The backpressure control module 300 can be coupled to the fuel cell stack and is configured to adjust the pressure and temperature of the exhaust gas from the fuel cell stack, making it suitable for discharge.

The gas supply control module 200 includes a mass flow controller 210 suitable for receiving dry gas. The dry gas may include hydrogen or air, or hydrogen or oxygen, and the mass flow controller 210 may be used to supply hydrogen to the cathode or the anode. The gas supply control module 200 also includes a mixing tube 220. The first end of the mixing tube 220 is coupled to the mass flow controller 210. The second end of the mixing tube 220 can receive steam. The dry gas from the mass flow controller 210 and the received steam are mixed in the mixing tube 220 to form humidified gas. The gas supply control module 200 also includes a first gas heat exchanger 230. The first gas heat exchanger 230 is coupled to the mixing tube 220 and is adapted to be coupled to the fuel cell stack 30.

The first gas heat exchanger 230 is configured to supply temperature-regulated humidified gas to the fuel cell stack 30.

As used herein, the term “comprising” and its variants will be interpreted as an open-ended term meaning “including but not limited to”. The term “based on” will be interpreted as “at least in part based on”. The term “an example” and “example” should be understood as “at least one example”. The term “another example” should be understood as “at least one other example”. The terms “first”, “second”, etc., may refer to different or the same objects. Other explicit and implicit definitions may be included below. Unless otherwise explicitly stated, the definitions of terms are consistent throughout the specification.

Although the subject matter has been described in language specific to structural features and/or logical operations of testing apparatus, it is to be understood that the subject matter defined in the appended claims is not necessarily limited to the specific features or operations described above. Rather, the specific features and operations described above are merely exemplary forms of implementing the claims.

What is claimed is:

1. A testing apparatus for a fuel cell stack, comprising:
a main body configured to house the fuel cell stack to be tested;
a gas supply control module detachably disposed in the main body, wherein the gas supply control module comprises (i) a mass flow controller configured to control the flow rate of received dry gas, wherein the dry gas comprises hydrogen or air, or hydrogen or oxygen, (ii) a mixing tube coupled to the mass flow controller and configured to receive steam, wherein the dry gas from the mass flow controller and the received steam are mixed into humidified gas in the mixing tube, and (iii) a first gas heat exchanger coupled to the mixing tube and configured to be coupled to the fuel cell stack, wherein the first gas heat exchanger is further configured to provide the fuel cell stack with temperature-regulated humidified gas; and
a backpressure control module detachably disposed in the main body and configured to be coupled to the fuel cell stack, the backpressure control module being further configured to regulate the pressure of the exhaust gas from the fuel cell stack.

2. The testing apparatus according to claim 1, wherein the gas supply control module further comprises a proportional valve coupled to the mixing tube and configured to regulate the mass of steam entering the mixing tube.

3. The testing apparatus according to claim 1, wherein the gas supply control module further comprises a second gas heat exchanger (i) coupled between the mixing tube and the mass flow controller, and (ii) configured to preheat the dry gas flowing from the mass flow controller to the mixing tube.

4. The testing apparatus according to claim 3, wherein:
the first gas heat exchanger and the second gas heat exchanger extend in parallel, and
the mixing tube extends from the first gas heat exchanger to the second gas heat exchanger in a direction perpendicular to the first gas heat exchanger.

5. The testing apparatus according to claim 4, wherein the mixing tube comprises (i) a tube body extending between the first gas heat exchanger and the second gas heat exchanger, and (ii) a steam pipeline communicating with the tube body and extending in a direction perpendicular to the tube body.

6. The testing apparatus according to claim 4, wherein:
the first gas heat exchanger comprises a first surface extending in a first direction,
the second gas heat exchanger comprises a third surface extending parallel to the first surface,
a humid gas inlet is provided on the first surface and a dry gas outlet is provided on the third surface, the humid gas inlet being aligned with the dry gas outlet, and
the mixing tube extends from the humid gas inlet to the dry gas outlet.

7. The testing apparatus according to claim 6, wherein the second gas heat exchanger further comprises a fourth surface perpendicular to the third surface, a dry gas inlet configured to be coupled to the mass flow controller being provided on the fourth surface.

8. The testing apparatus according to claim 6, wherein the first gas heat exchanger further comprises a second surface perpendicular to the first surface, a humid gas outlet configured to be coupled to the fuel cell stack being provided on the second surface.

9. The testing apparatus according to claim 1, wherein the gas supply control module further comprises a fourth gas heat exchanger coupled to the inlet of the mass flow controller and configured to preheat the dry gas entering the mass flow controller.

10. The testing apparatus according to claim 1, wherein the backpressure control module comprises:
a backpressure valve configured to regulate the pressure of the exhaust gas; and
a third gas heat exchanger configured to regulate the temperature of the exhaust gas.

11. The testing apparatus according to claim 10, wherein:
the third gas heat exchanger is coupled to the fuel cell stack, and one end of the backpressure valve is coupled to the third gas heat exchanger, the other end of the backpressure valve being configured to be coupled to an exhaust gas treatment device, or
one end of the backpressure valve is coupled to the fuel cell stack, and the other end of the backpressure valve is coupled to the third gas heat exchanger, the third gas heat exchanger being configured to be coupled to an exhaust gas treatment device.

12. The testing apparatus according to claim 4, further comprising additional gas supply control modules and additional backpressure control modules for other test powers,
wherein the additional backpressure control modules and the additional gas supply control modules are configured to be disposed in the main body to replace the gas supply control module and the backpressure control module.

13. A testing system for a fuel cell stack, comprising:
the testing apparatus for a fuel cell stack according to claim 1; and
a fuel cell stack comprising (i) an input end coupled to the gas supply control module in the testing apparatus, and (ii) an output end coupled to the backpressure control module in the testing apparatus.

14. The testing system according to claim 13, further comprising a steam source disposed outside or inside the testing apparatus and configured to provide steam.
